(19) United States
(12) Patent Application Publication
(10) Pub. No.: US 2017/0352117 A1
(43) Pub. Date: Dec. 7, 2017

(54) AUTOMATED COHORTS FOR SESSIONS

(71) Applicant: COURSERA, INC., Mountain View, CA (US)

(72) Inventors: Jonathan WONG, Mountain View, CA (US); Nathan RAHN, San Jose, CA (US); Kapeesh SARAF, Mountain View, CA (US); Melody KIM, San Francisco, CA (US); Leith ABDULLA, Menlo Park, CA (US); Grace KWAN, Mountain View, CA (US); Priya GUPTA, Santa Clara, CA (US); Wang Shuen JOU, San Francisco, CA (US); Minjeong KIM, Cupertino, CA (US)

(21) Appl. No.: 15/170,440

(22) Filed: Jun. 1, 2016

(51) Int. Cl. G06Q 50/20; G06Q 10/10

(52) U.S. Cl. CPC G06Q 50/2053; G06Q 10/10

(57) ABSTRACT

In one general aspect, a computer-implemented method can include scheduling a respective available open enrollment period for each of a plurality of cohort sessions for an online course, determining that a first cohort session included in the plurality of cohort sessions for the online course is open for enrollment, enrolling, based on determining the first cohort session is open for enrollment, a learner in the first cohort session, automatically tracking a progress for the enrolled learner, determining, based on automatically tracking the progress for the learner, that the learner is falling behind a predetermined schedule of course completion for the online course, and, based on determining that the learner is falling behind the predetermined schedule, automatically determining that a second cohort session included in the plurality of cohort sessions for the online course is open for enrollment, and enrolling the learner in the second cohort session.

### TECHNICAL FIELD

This description generally relates to a format for on-line courses.

### BACKGROUND

A student can enroll in an online course in an on demand basis allowing the student to customize how they take the course. In some cases, the student can select, for example, when they want to take the course, and the duration of the course. This flexibility can allow the student the ability to customize a learning experience for the student based on a personal schedule and availability.

### SUMMARY

In one general aspect, a computer-implemented method can include scheduling, by a computer system, a respective available open enrollment period for each of a plurality of cohort sessions for an online course, determining, by the computer system, that a first cohort session included in the plurality of cohort sessions for the online course is open for enrollment, enrolling, by the computer system and based on determining the first cohort session is open for enrollment, a learner in the first cohort session, automatically tracking, by the computer system, a progress for the learner enrolled in the first cohort session, and determining, by the computer system and based on automatically tracking the progress for the learner, that the learner is falling behind a predetermined schedule of course completion for the online course. The computer-implemented method can include, based on determining that the learner is falling behind the predetermined schedule, automatically determining, by the computer system, that a second cohort session included in the plurality of cohort sessions for the online course is open for enrollment, and enrolling, by the computer system and based on automatically determining that the second cohort session is open for enrollment, the learner in the second cohort session, the enrolling including retaining, by the computer system, a current progress of the learner through the online course, the retaining including moving completed course assessments from the first cohort session to the second cohort session.

Example implementations may include one or more of the following features, alone or in combination with one or more other features. For example, the computer-implemented method can further include providing, by the computer system and to a computing device, an indication that the first cohort session is open for enrollment, and receiving, by the computer system and from the computing device, data indicative of a selection of the first cohort session by the learner. The computer-implemented method can further include providing, by the computer system and to the computing device, an indication that the second cohort session included in the plurality of cohort sessions is open for enrollment, and receiving, by the computer system and from the computing device, data indicative of a selection of the second cohort session by the learner. The indication that the first cohort session is open for enrollment can be displayed in a first user interface on a display device included in a computing device. The indication that the second cohort session is available for enrollment can be displayed in a second user interface on the display device included in the computing device. The indication that the learner is falling behind schedule can be displayed in a third user interface on the display device included in the computing device. The enrolling can include enabling, by the computer system, preview access to the online course, the preview access including access to a subset of course content for the online course. The preview access can further include access to a subset of course assessments for the online course. A portion of a time duration for the preview access can overlap a portion of a time duration for the first cohort session. The portion of the time duration for the preview access can be at a start of the first cohort session. The second cohort session can be available for enrollment subsequent to a final deadline for the first cohort session. A portion of a time duration for the first cohort session can overlap with a portion of a time duration for the second cohort session. Automatically tracking a progress for the learner enrolled in the first cohort session can include performing, by the computer system, a check of course progress for the learner before an end of the online course. Automatically tracking a progress for the learner enrolled in the first cohort session can include performing, by the computer system, a check of course progress for the learner before a final deadline for the online course, wherein the final deadline is at an end of a grace period for the online course. The computer-implemented method can further include determining, by the computer system, a number and frequency of offering of the plurality of cohort sessions based on at least one of enrollment data for the online course and learner demand for the online course. Scheduling a respective available enrollment period for each of the plurality cohort sessions can include providing continuous open enrollment for the online course. The first cohort session can include a first plurality of learners enrolled in the first cohort session. The second cohort session can include a second plurality of learners enrolled in the second cohort session.

In another general aspect, a computer system can include an online course repository including a plurality of online courses and a schedule for completion of each online course, a student repository including a plurality of outcomes of completed course assessments for a cohort session for an online course, the plurality of outcomes of completed course assessments being stored in the student repository in association with respective learners enrolled in the cohort session for the online course. The computer system can include a server. The server can include a course application module configured to present content and course assessments to a learner enrolled in a cohort session for the online course, and an auto-cohort session manager application module. The auto-cohort session manager application module can be configured to schedule a respective available open enrollment period for each of a plurality of cohort sessions for an online course, determine that a first cohort session included in the plurality of cohort sessions for the online course is open for enrollment, enroll a learner in the first cohort session, access the student repository in order to monitor a progress for the learner, the monitoring including accessing a plurality of outcomes of completed course assessments for the first cohort session, the plurality of outcomes being associated with the learner, determine that the learner is falling behind a schedule for completion of the online course, based on determining that the learner is falling behind the schedule, determine that a second cohort session included in the plurality of cohort sessions for the online course is open for enrollment. The auto-cohort session manager application module can be configured to, based on determining that the second cohort session is open for enrollment, enroll the learner in the second cohort session, and retain, in association with the learner, the plurality of outcomes of completed course assessments for first cohort session.

Example implementations may include one or more of the following features, alone or in combination with one or more other features. For example, the auto-cohort session manager application module can be further configured to access the student repository before an end of the online course when monitoring the progress for the learner. The online course repository can include, in association with each online course, enrollment data for the online course and learner demand data for the online course. The auto-cohort session manager application module can be further configured to determine a number of cohort sessions to include in the plurality of cohort sessions for the online course based on at least one of the enrollment data for the online course and the learner demand data for the online course.

In yet another general aspect, a non-transitory, machine-readable medium can have instructions stored thereon. The instructions, when executed by a processor, can cause a computer system to schedule, by the computer system, a respective available open enrollment period for each of a plurality cohort sessions for an online course, determine, by the computer system, that a first cohort session included in the plurality of cohort sessions for the online course is open for enrollment, enroll, by the computer system and based on determining the first cohort session is open for enrollment, a learner in the first cohort session, track, by the computer system, a progress for the learner enrolled in the first cohort session, and determine, by the computer system and based on automatically tracking the progress for the learner, that the learner is falling behind a predetermined schedule of course completion for the online course. The instructions, when executed by a processor, can cause the computer system to, based on determining that the learner is falling behind the predetermined schedule, determine, by the computer system, that a second cohort session included in the plurality of cohort sessions for the online course is open for enrollment, and enroll, by the computer system and based on automatically determining that the second cohort session is open for enrollment, the learner in the second cohort session, the enrolling including retaining, by the computer system, a current progress of the learner through the online course, the retaining including moving completed course assessments from the first cohort session to the second cohort session.

Example implementations may include one or more of the following features, alone or in combination with one or more other features. For example, the instructions, when executed by the processor, that cause the computer system to the enroll a learner in the first cohort session can include instructions that, when executed by the processor, cause the computer system to enable preview access to the online course, the preview access including access to a subset of course content for the online course. The preview access can further include access to a subset of course assessments for the online course.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of an example system that can be used for cohort sessions.

FIG. 2 is a diagram showing an example timeline for an auto-cohort session that is re-run on a regular schedule.

FIG. 3 is a diagram of an example user interface that provides an enrollment interface and a confirmation interface for an online course for an example university.

FIG. 4 is a diagram of an example user interface that provides a discussion forum interface for an automated cohort session for an online course.

FIG. 5 is a diagram of an example user interface that provides a peer review interface for phased peer review of graded peer assessments for an automated cohort session for an online course.

FIG. 6 is a diagram of an example user interface that provides a message to a learner.

FIG. 7 is a diagram of an example user interface that provides a message to a learner that has selected to enroll in a subsequent cohort session.

FIG. 8 is a diagram of an example user interface that provides an announcement interface to an instructor.

FIG. 9 is a flowchart that illustrates a method for enrolling a learner in a cohort session.

FIG. 10 shows an example of a computer device and a mobile computer device that can be used to implement the techniques described here.

Like reference symbols in the various drawings indicate like elements.

### DETAILED DESCRIPTION

Many online courses can provide learners (also referred to herein as students) the ability to take self-paced, on-demand courses within the comfort of their home, outside of the structure of a traditional classroom setting. The online courses can provide a type of virtual classroom to the learner that includes all of the advantages of a classroom setting, such as collaboration among students, and the ability to ask questions of a mentor, teacher, or professor (an individual who orchestrates the course, e.g., an instructor) without many of the disadvantages of a course offered in a traditional classroom setting, such as a more strict adherence to scheduling. For example, a ten-week long course can have lectures scheduled and assignments due at particular times during the duration of the course. If a student misses a lecture or does not hand in certain assignments when due, the learning and grade of the student can be negatively impacted. In addition or in the alternative, the student may not complete the course on schedule requiring them to have to retake the course, starting over with the lectures and course assignments.

In some implementations, an online course can be self-paced, providing students with a type of structure that can adjust for the individual needs of a student without the student having to lose or repeat work already completed in the course, if the student should fall behind in the course. A cohort can be a group of learners or students that are signed up for (enrolled in) a same session of an online course. The session can be referred to as a cohort session. In some implementations, a cohort session will always be available for (open for) enrollment for a given online course. When enrollment for one cohort session for an online course closes, enrollment for another cohort session of the online course will open. In some implementations, two or more cohort sessions for an online course can overlap. In some implementations, more than one (two or more) cohort sessions can be offered at the same time.

A student can always have available to them a cohort session that they can join or enroll in for a given online course. Providing auto-scheduled cohort sessions for an online course can result in continual open enrollment for the online course. Not only can a student decide when to start the online course but also, if a student falls behind, the student can enroll in a subsequent (e.g., the next) cohort session. The progress of the student can be maintained between the cohort sessions. For example, a student does not have to resubmit past assignments completed in a previous cohort session. The student can also benefit from taking an on-demand online course with a group of classmates included in a particular cohort session. Forums, peer review, and other collaborative learning tools and techniques can be available for use in and included in a cohort session.

The cohort sessions for an online course can be provided automatically with little, if any, intervention by the instructor for the online course. In some implementations, automatically offered cohort sessions (also referred to herein as auto-cohort sessions or cohort sessions) can be offered serially (e.g., a second cohort session is made available at the closing of a first cohort session). In some implementations, auto-cohort sessions can be offered in parallel (e.g., two or more cohort sessions for an online course may have staggered starts and overlap for open enrollment during a certain time frame (e.g., one week)). The offering of the auto-cohort sessions can be based on many criteria that can include, but are not limited to, the number of students interested in enrolling in the online course, the particular time of the year in which the online course is offered (e.g., larger student enrollment during the courses offered in the fall as compared to the courses offered in the spring), and the availability of one or more course instructors.

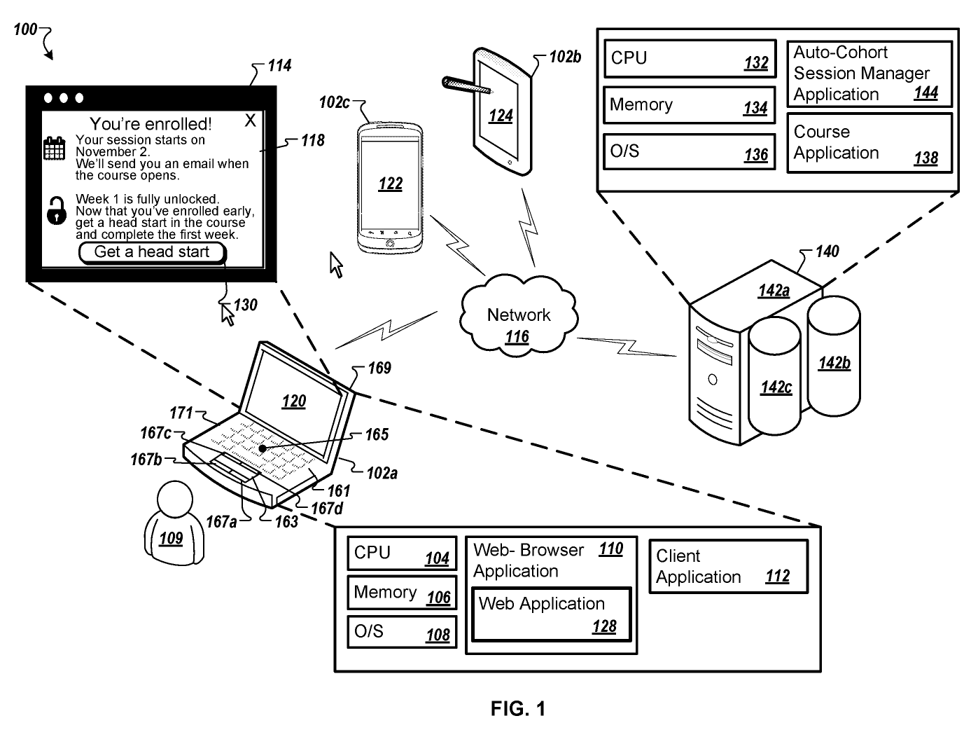

FIG. 1 is a diagram of an example system 100 that can be used for cohort sessions. The example system 100 includes a plurality of computing devices 102a-c (e.g., a laptop or notebook computer, a tablet computer, and a smart phone, respectively). An example computing device 102a (e.g., a laptop or notebook computer) can include one or more processors (e.g., a client central processing unit (CPU) 104) and one or more memory devices (e.g., a client memory 106). The computing device 102a can execute a client operating system (O/S) 108 and one or more client applications, such as a web browser application 110 and one or more client applications (e.g., client application 112) that the computing device 102a can execute. The web browser application 110 can display a user interface (UI) (e.g., a web browser UI 114) on a display device 120 included in the computing device 102a. Though not shown in FIG. 1, the computing devices can also include a desktop computing device.

The system 100 includes a computer system 140 that can include one or more computing devices (e.g., a server 142a) and one or more repositories or databases (e.g., repositories 142b-c). For example, the computer system can include an online course repository 142b and a student repository 142c. The server 142a can include one or more processors (e.g., a server CPU 132), and one or more memory devices (e.g., a server memory 134). The computing devices 102a-c can communicate with the computer system 140 (and the computer system 140 can communicate with the computing devices 102a-c) using a network 116.

The server 142a can execute a server O/S 136. The server 142a can provide online course content (e.g., an auto-cohort session) that can be included in (stored in) the online course repository 142b in association with an online course. The server 142a can execute a course application 138 that can provide the content of an online course to the computing devices 102a-c using the network 116. The course application 138 can be a module included in the server 142a.

The main server 142a can include an auto-cohort session manager application 144 that can manage auto-cohort sessions for a user (e.g., user 109) of any of the computing devices 102a-c. The auto-cohort session manager application 144 can be a module included in the server 142a. The user 109 can be a student enrolled in (or preparing to enroll in) an online course that offers auto-cohort sessions. The auto-cohort session manager application 144 can interface with the repositories 142b-c and the course application 138 when offering and managing auto-cohort sessions for a student.

In some implementations, the computing devices 102a-c can be laptop or desktop computers, smartphones, personal digital assistants, tablet computers, or other appropriate computing devices that can communicate, using the network 116, with other computing devices or computer systems. In some implementations, the computing devices 102a-c can perform client-side operations, as discussed in further detail herein. Implementations and functions of the system 100 described herein with reference to computing device 102a, may also be applied to computing device 102b and computing device 102c and other computing devices not shown in FIG. 1 that may also be included in the system 100. The computing device 102b includes a display area 124. The computing device 102c includes a display area 122.

The computing device 102a includes the display device 120 included in a lid portion 169 and one or more input devices included in a base portion 171. The one or more input devices can include, for example, a keyboard 161, a trackpad 163, a pointer button 165, and mouse buttons 167a-d. The computing device 102b can include a display area 124 that can include a touchscreen. The computing device 102c can include a display area 122 that can include a touchscreen. A student (e.g., user 109) can interact with one or more input devices and/or a touchscreen when accessing, viewing, and interacting with online course content displayed in a user interface on the display device 120.

In some implementations, the server 142a can represent more than one computing device working together to perform server-side operations. In this example, a single proprietor can provide the multiple servers. In some cases, the one or more of the multiple servers can provide other functionalities for the proprietor.

In some implementations, the network 116 can be a public communications network (e.g., the Internet, cellular data network, dialup modems over a telephone network) or a private communications network (e.g., private LAN, leased lines). In some implementations, the computing devices 102a-c can communicate with the network 116 using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

In some implementations, the web browser application 110 can execute or interpret a web application 128 (e.g., a browser-based application). The web browser application 110 can include a dedicated user interface (e.g., the web browser UI 114). The web application 128 can include code written in a scripting language, such as AJAX, JavaScript, VBScript, ActionScript, or other scripting languages. The web application 128 can display a web page 118 in the web browser UI 114. The web page can include one or more areas of static information (e.g., text, images, etc.). The web page 118 can include one or more user-selectable buttons (e.g., head start button 130) that a student can select when enrolling or participating in an online course.

In a non-limiting example, as shown in FIG. 1, the web page 118 can include information confirming the enrollment of a student in an online course. The web page can include the head start button 130 that when selected by the student allows the student to begin the online course before the actual official start date for the course. The web page 118 can be constructed (created, rendered, or built) by the web application 128.

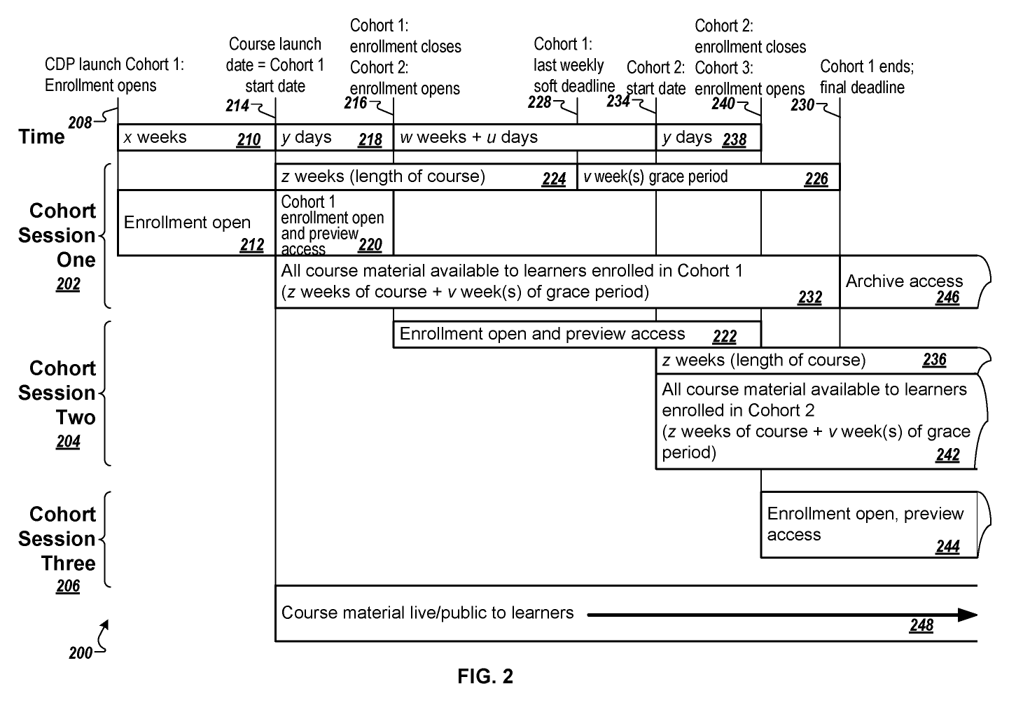

FIG. 2 is a diagram showing an example timeline 200 for an auto-cohort session that is re-run on a regular schedule. The example timeline 200 shows the rerunning of an automated cohort in three sessions (e.g., cohort session one 202, cohort session two 204, and cohort session three 206). Though FIG. 2 shows three example cohort sessions (cohort session one 202, cohort session two 204, and cohort session three 206) in some implementations more cohort sessions can be run (e.g., a cohort session can be re-run more than two times). In some implementations, fewer cohort sessions can be run.

At a first time 208, a course description page (CDP) can be launched and enrollment for a cohort session one 202 can begin. For a first time duration 210 (e.g., x weeks), enrollment for the cohort session one 202 is open (e.g., enrollment open 212). Students can enroll in the online course during the first time duration 210 when the enrollment is open. In a non-limiting example, the first time duration 210 can be three weeks (e.g., x=3).

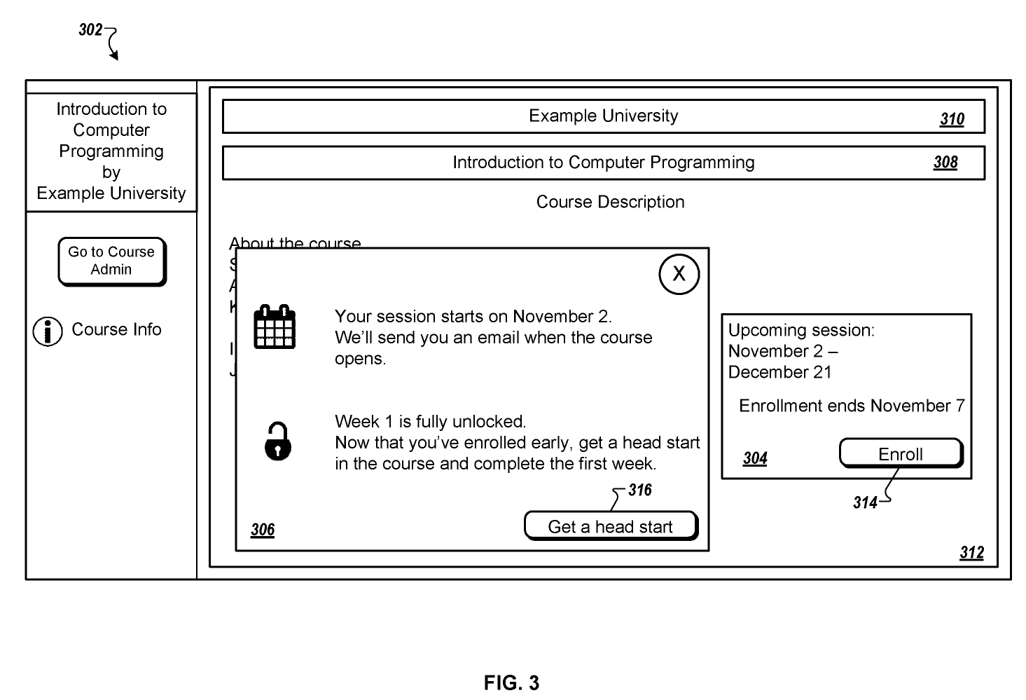

FIG. 3 is a diagram of an example user interface 302 that provides an enrollment interface 304 and a confirmation interface 306 for an online course 308 for an example university 310. The user interface 302 also includes a course description 312. For example, referring to FIG. 1, a student can interact with a web application 128 that can access the course application 138. The course application 138 can access the online course repository 142b to provide the online course 308 to the student on the computing device 102a. In addition, the auto-cohort session manager application 144 can determine if auto-cohort sessions are available for the online course. If auto-cohort sessions are available, the auto-cohort session manager application 144 can determine how many are available and how the auto-cohort sessions can be offered to a student.

For example, the user interface 302 can be displayed on the display device 120 of the computing device 102a. Referring back to FIG. 1, a student (e.g., user 109) can interact with the one or more input devices and/or a touchscreen when accessing, viewing, and interacting with the user interface 302. A student, interacting with the enrollment interface 304, can select an enroll button 314. Upon selection of the enroll button 314, the student is enrolled in the online course 308 and, in particular, the cohort session one 202 for the online course 308. The confirmation interface 306 can provide confirmation to the student of the enrollment.

In some cases, before enrolling in the online course, a student can preview the material for the first week of an online course. The student may not preview any assessments. In some implementations, after enrolling, a student can preview the material for the first week of an online course and can preview the assessments. The student can preview the course materials and assessments while waiting for the cohort session of the online course to begin. In some cases, a student can get a head start in the course by completing the first week of the course before the cohort session one 202 (and before the offering of the online course) officially launches or begins. For example, the student can begin by selecting a get a head start button 316. A progress of the learner during the preview can be saved and applied to an overall progress on the learner when (and if) the learner decides to enroll in the online course.

Referring back to FIG. 2, the online course is launched at a second time 214 (e.g., x weeks (the first time duration 210) after the first time 208). The launch date for the online course is equal to (the same as) the start date for the cohort session one 202. At a third time 216 (e.g., a second time duration 218 (e.g., y days) after the first time duration 210 (e.g., x weeks)), the enrollment for the cohort session one 202 closes and enrollment for the cohort session two 204 opens. In a non-limiting example, the second time duration 218 can be four days (e.g., y=4). If the learner attempts to enroll in the cohort session one 202 after the enrollment for the cohort session one 202 close (after (later than) the third time 216), the learner can be invited to enroll in the cohort session two 204, the next cohort session for the online course.

Between the second time 214 and the third time 216, enrollment for cohort session one 202 is open and course preview access is granted to the student (e.g., cohort session one enrollment open and preview access 220). The cohort session one enrollment open and preview access 220 overlaps with the duration of the online course that starts at the second time 214. The overlap is of the second time duration 218 (e.g., y days). During the overlap (the second time duration 218 (e.g., y days)), the enrollment for the cohort session one 202 remains open and preview access is allowed for the cohort session one 202.

At the third time 216, enrollment for cohort session two 204 opens and course preview access is granted to the student (e.g., cohort session two enrollment open and preview access 222).

A duration (length) of the online course can be z weeks. The length of the online course can be the same for each cohort session. A length of the online course for the cohort session one 202 can be the duration of the course starting at the second time 214 and ending z weeks later (e.g., z weeks (length of course) 224). In some implementations, as shown in FIG. 2, a grace period (e.g., v week(s) grace period 226) can be added to the duration of the online course at, for example, the end of the online course at a fourth time 228. The grace period can be an amount of allowed time that a student can use to complete the cohort session one 202 of the online course (e.g., make up lessons, submit assignments, access online assessments, etc.). In a non-limiting example, a length of the online course can be four weeks (e.g., z=4) and a grace period can be one week (e.g., v=1).

All course materials are available to learners enrolled in the cohort session one 202 from the course launch date at the second time 214 until the end of the grace period at a fifth time 230 (e.g., all course material available to learners enrolled in cohort session one 232). The cohort session one 202 ends at the fifth time 230. The fifth time 230 is the final deadline for the cohort session one 202. The end of the cohort session one 202 of the online course at the fourth time 228 provides a last weekly soft deadline for the cohort session one 202 of the online course. For example, over the duration of the cohort session one 202 of the online course soft deadlines can be set for completion of course assignments. However, in order for a student to successfully complete the cohort session one 202 of the online course (and receive a grade for the course), course assignments and assessments (e.g., quizzes and tests) must be completed, handed in, and accounted for by the fifth time 230 (the final deadline for the cohort session one 202 of the online course). At the fifth time 230, access to the cohort session one 202 is archived (e.g., archive access 246) and the learner can no longer view or submit assignments for the cohort session one 202.

As shown in the example timeline 200, cohort session two 204 starts at a sixth time 234. The sixth time 234 is after the end (or completion) of the cohort session one 202 at the fourth time 228 but before the end of the grace period 226 at the fifth time 230. A part of the duration for an enrollment open and preview access 222 overlaps with the duration of the cohort session two 202 for the online course that starts at the sixth time 234 and ends z weeks later (e.g., z weeks (length of course) 236). The overlap is of a third time duration 238 (e.g., y days) that starts at the sixth time 234 and ends at a seventh time 240. During the overlap (the third time duration 238 (e.g., y days)) the enrollment for the cohort session two 204 remains open and preview access is allowed for the cohort session two 204. In a non-limiting example, a length of the online course can be four weeks (e.g., z=4) and the third time duration 238 can be four days (e.g., y=4).

All course materials are available to learners enrolled in the cohort session two 204 starting at the course launch date at the sixth time 234 (e.g., all course material available to learners enrolled in cohort session two 242). Though not shown in FIG. 2, cohort session two 204 can have a grace period and weekly soft deadlines as shown for the cohort session one 202. At the seventh time 240, enrollment for cohort session three 206 opens and course preview access is granted to the student (e.g., cohort session three enrollment open and preview access 244).

The pattern of availability of a cohort session can continue as shown in FIG. 2 until there are no further cohort sessions offered (available) for the online course. As long as a cohort session is offered and available for enrollment, course material is live and made public to learners 248. Once a learner has enrolled in a cohort session and the cohort session has started, a learner can move through the content of the online course at their own pace (as quickly as they would like to). The use of automated cohort sessions can accommodate a variety of paces of a learner though an online course, allowing a slower paced learner to complete the online course in another cohort session without losing the progress made during a current cohort session.

In some implementations, the duration of the online course (e.g., z weeks (length of course) 224) for the cohort session one 202 can be the same as (equal to) the duration of the online course (e.g., z weeks (length of course) 224) for the cohort session two 204.

Once an online course launches, there should always be a cohort session open for enrollment. For example, when enrollment for one cohort session closes enrollment for another cohort session opens. The duration of the online course (e.g., z weeks (length of course)) for each cohort session of the online course can be the same. Automated cohort sessions can be regularly re-run. The frequent re-running of automated cohort sessions can provide improved learner retention and course completion because of the added flexibility of scheduling of an online course that the automated cohort sessions can provide to a learner. Automated cohort sessions that are regularly re-run provide a cohort session that is always available (open) for enrollment of a learner providing the learner with uninterrupted course material accessible to the learner because a learner can merely join the cohort session currently open for enrollment. The automated cohort sessions can be layered on top of open courses to provide a learner with a structured experience for the online course, providing additional structure to a self-paced online course. The automatic re-running of the automated cohort sessions on a repeatable schedule (e.g., every four weeks, monthly, bi-monthly) as described herein leverages the many benefits of on-demand online courses. In addition, the number and frequency of the re-running of the cohort sessions can be determined based on many factors including enrollment data for the online course.

The re-running of automated cohort sessions provides a learner with the option of previewing the online course during a herein described overlap time duration where the enrollment for the cohort session remains open while the cohort session is started. During the preview of the online course, a learner can view the course content but will not have access to any of the course assessments including the course assignments.

Before or during this overlap time duration, the learner can also enroll in the particular cohort session of the online course. Once enrolled, a learner joins a cohort session (along with other learners enrolled in the same cohort session). Once the learner joins a cohort session, if the cohort session has not yet started (a start date for the cohort session has yet to occur), the learner can have access to the course content and assessments for the first week (e.g., week one) of the online course. This can allow the learner to get a head start on the course. If the learner enrolls in and joins a cohort session after the cohort session has started (a start date for the cohort session has passed) but before the enrollment for the cohort session ends, the learner can have access to all of the course content and assessments. If the learner is unable to complete the online course within a first cohort session (by the final hard deadline for the cohort session), the learner can enroll in and join a subsequent cohort session once enrollment for the subsequent cohort session opens. The assignments and assessments completed by the learner in the first cohort session can be rolled into (provided to) the second cohort session. The course progress of the user, therefore, can be maintained.

An instructor can determine a reasonable length for the duration of a cohort session (the duration of the online course) based on what the instructor thinks is an amount of work that a learner can reasonable complete each week for the weeks included in the cohort session for the online course. The number and frequency of the automated cohort sessions can be determined based on one or more factors. The factors can include, but are not limited to, instructor availability, learner demand for the course, enrollment data for the course, and the time of the year (e.g., the course may not be offered during the summer months). An instructor of an online course that provides re-running of automated cohort sessions can manage the online course as an always available (for a particular course length (e.g., length of course as described herein)) online course.

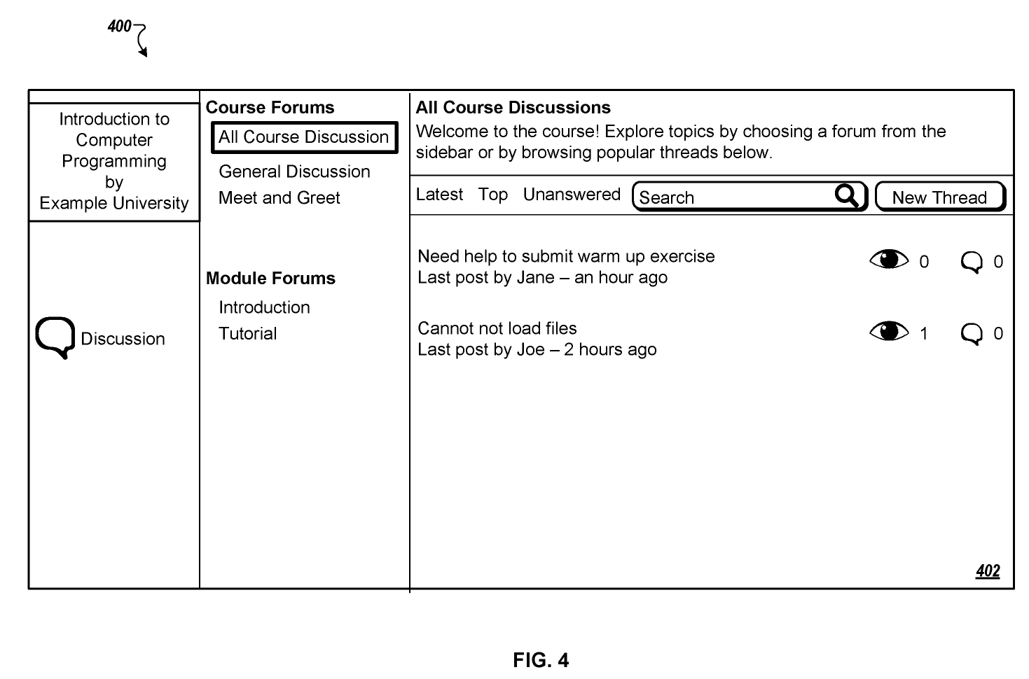

FIG. 4 is a diagram of an example user interface 400 that provides a discussion forum interface 402 for an automated cohort session for an online course. For example, referring to FIG. 2, the discussion forum interface 402 can be for the cohort session one 202. Learners will only see discussions (threads) for the cohort session that they are enrolled in. An instructor can pin specific threads (designate specific discussions) to be visible to a particular cohort session for an online course. In addition or in the alternative, an instructor can pin specific threads (designate specific discussions) to be visible across (be persistent across) all cohort sessions of the online course.

In some implementations, instructor(s) and mentor(s) associated with the online course can have access to discussion forums associated with each cohort session. In some implementations, for example as described with reference to FIG. 2, course material can be available during a particular time duration in multiple (e.g., two) cohort sessions. The instructor(s) and mentor(s) can access all discussion forums across the cohort sessions. In some implementations, instructor(s) can send email announcements to particular individual cohort sessions as needed.

Course content can be organized on a weekly basis. An instructor can determine which course modules correspond to each week of the online course. In some implementations, the schedule for the course content can be the same for each cohort session for the online course. In some implementations, the schedule for the course content may vary between each cohort session offered for the online course. In some implementations, a soft deadline for the online course can be set at the end of each week of the online course.

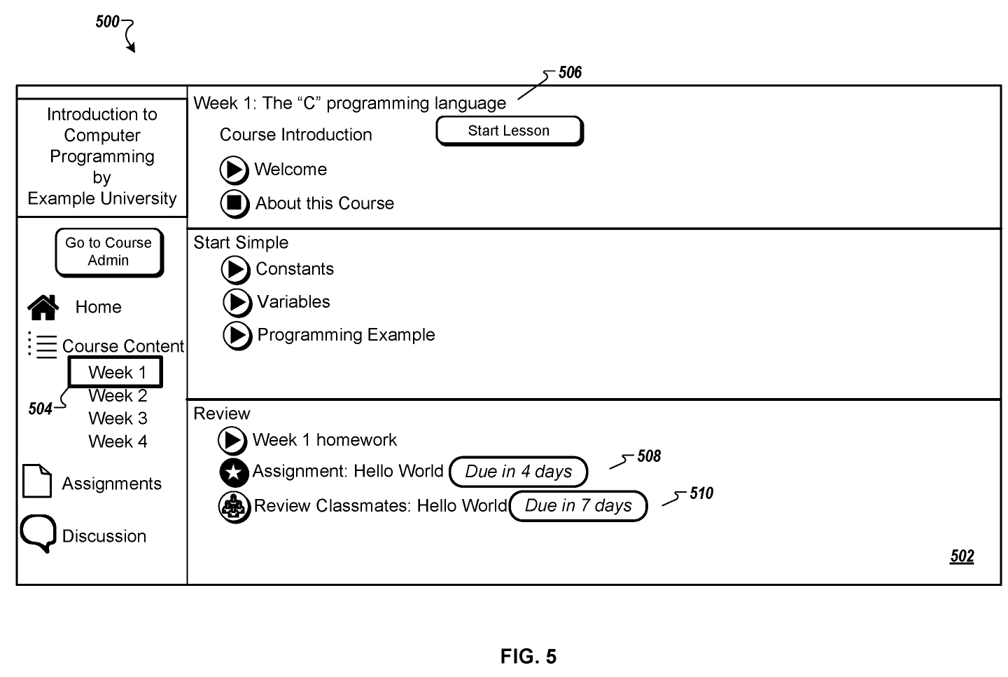

FIG. 5 is a diagram of an example user interface 500 that provides a peer review interface 502 for phased peer review of graded peer assessments for an automated cohort session for an online course. In the example shown in FIG. 5, the peers are all enrolled in the same cohort session as a particular learner. The user interface 500 is shown for a specific week (e.g., Week 1 as shown by the selection of Week1 entry 504 and a week designation 506). A peer assessment is shown as two separate items; a submit phase 508 and a review phase 510. In some implementations, a learner submits an assignment for the learner before the learner can view (review) an assessment of a peer. In some implementations, an on-time submission for an assignment can be prioritized to receive evaluations ahead of late submissions for the same assignment. Learners can, however, submit assignments at any time before the cohort session for the course ends (before a final deadline for the cohort session).

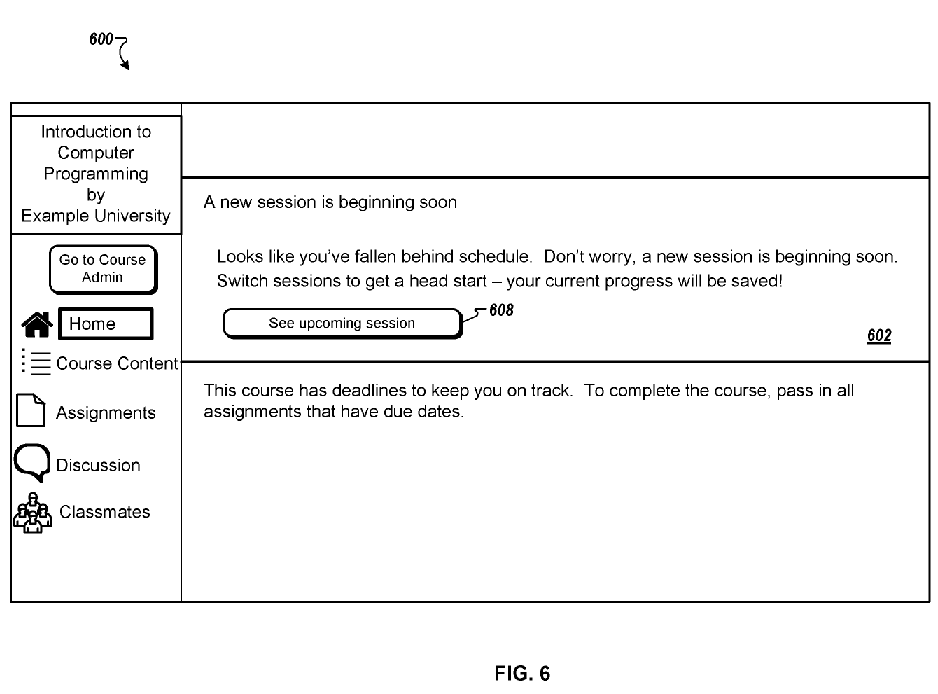

FIG. 6 is a diagram of an example user interface 600 that provides a message 602 to a learner. For example, referring to FIG. 1, the auto-cohort session manager application 144 can monitor (or track) the progress of a learner through a cohort session. For example, an instructor can include a predetermined schedule for completion of the auto-cohort session that can be stored with the course content and course assessments (the online course) in a database (e.g., the online course repository). Information about the particular cohort session the learner is enrolled in can be stored in a database (e.g., the student repository) in association with the learner and the particular cohort session. The course application 138 can receive and record the outcome of course assessments (e.g., assignments, quizzes, tests) for the auto-cohort session that the learner is enrolled in. The course application 138 can record (store) the outcome of the course assessments completed by a learner in the student repository 142c in association with the learner and the particular auto-cohort session the learner is enrolled in. The auto-cohort session manager application 144 can monitor (or track) the progress of the learner through the online course by accessing the information for the learner, which is associated with the auto-cohort session that is included in the student repository 142c.

In some cases, referring to FIG. 2, the auto-cohort session manager application 144 can compare the current progress of the learner to a predetermined progress of a learner through the course at a point in time before the end of the online course (e.g., before the fourth time 228). In some cases, the auto-cohort session manager application 144 can compare the current progress of the learner to a predetermined progress of a learner through the course at a point in time before the final deadline and the end of a grace period (e.g., before the fifth time 230).

If the auto-cohort session manager application 144 determines that the learner is falling behind schedule, the auto-cohort session manager application 144 can generate the message 602 and provide it to the computing device 102a by way of the network 116 for display in the user interface 600 on the display device 120 of the computing device 102a.

In some cases, the auto-cohort session manager application 144 can compare the current progress of the learner to a predetermined progress of a learner through the course at the point in time during the course that the learner is currently accessing.

In cases where the auto-cohort session manager application 144 determines that the learner has fallen behind schedule in the current cohort session the learner is enrolled in, the auto-cohort session manager application 144 can provide the message 602 to the computing device 102a for display in the user interface 600. The learner can select the see upcoming session button 608 to see information about and to subsequently enroll in the next offered cohort session for the online course. Providing this message 602 can help keep the learner on track for successfully completing the course. The learner has the option of remaining in the cohort session they are currently enrolled in, working harder to fulfill the course requirements before the cohort session they are enrolled in closes. In the alternative, the learner has the option of enrolling in a next cohort session, keeping their current progress (e.g., lessons completed, assignments completed and handed in, completed course assessments) intact, moving it to the next cohort session. The learner can retain their current progress through the online course up to the point in time in the online course where they enrolled into the next cohort session. Enrolling in the next cohort session give the learner additional time to complete the online course without losing any traction made to date in the online course.

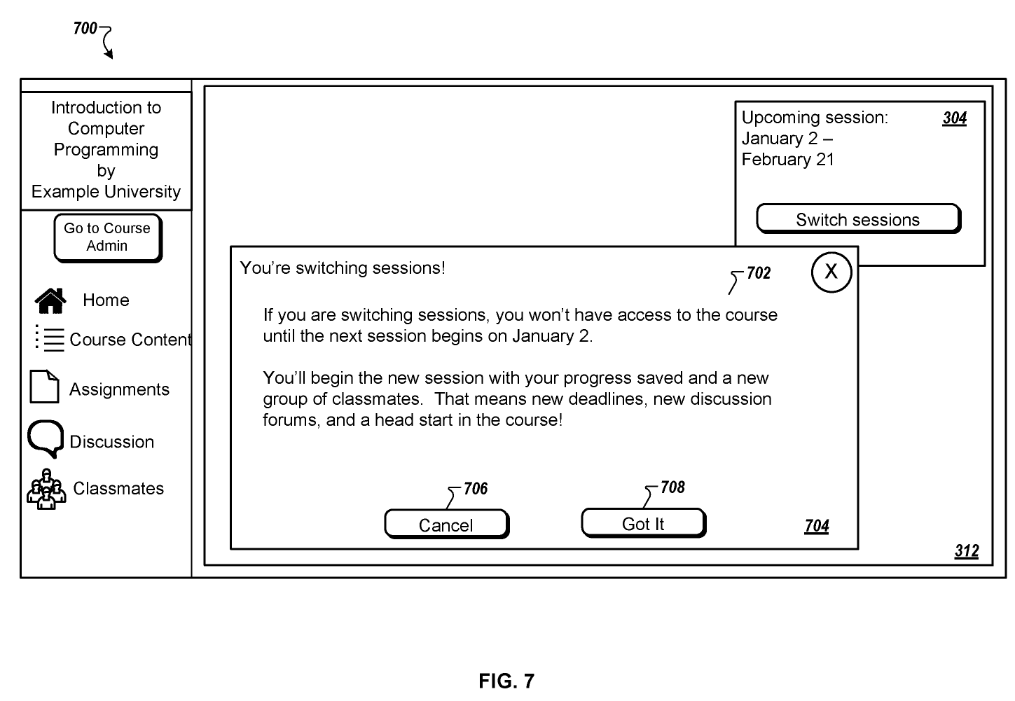

FIG. 7 is a diagram of an example user interface 700 that provides a message 702 to a learner that has selected to enroll in a subsequent cohort session. The message 702 can be included in a session switching user interface 704 that includes a cancel button 706 and a got it button 708. The learner can select the got it button 708. Subsequent to the selection of the got it button 708, the learner is enrolled in the next cohort session. The learner can select the cancel button 706. Subsequent to the selection of the cancel button 706, the learner will remain enrolled in the current cohort session and will not be enrolled in the subsequent cohort session.

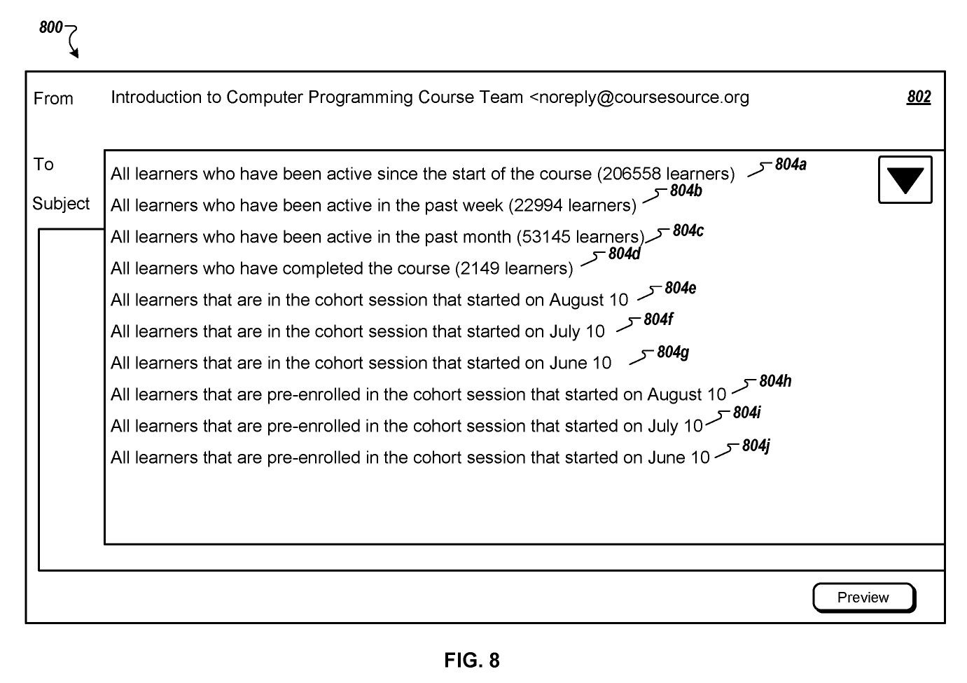

FIG. 8 is a diagram of an example user interface 800 that provides an announcement interface 802 to an instructor. The announcement interface 802 allows an instructor to email particular cohorts of learners (e.g., learners enrolled in a specific cohort session, learners pre-enrolled in a specific cohort session, learners based on their past and current level of activity in the course). The announcement interface 802 allows an instructor to select and email a particular subset of learners selected from the example learner subsets 804a-j. In some cases, the instructor can select and email a particular subset of learners (e.g., a first group of learner subsets included in the learner subsets 804a-j) in the online course at once without regard to the particular cohort session the learners are enrolled in (e.g., learner subsets 804a-d). In some cases, the instructor can select and email a particular subset of learners in the online course at once based on the particular cohort session the learners are enrolled in. For example, the instructor can choose to send email to the learners included in the learner subset 804e because the learners in the learner subset 804e are all enrolled in the same cohort session. In some cases, the instructor can send an email to all of the learners included in all of the learner sunsets 804a-j.

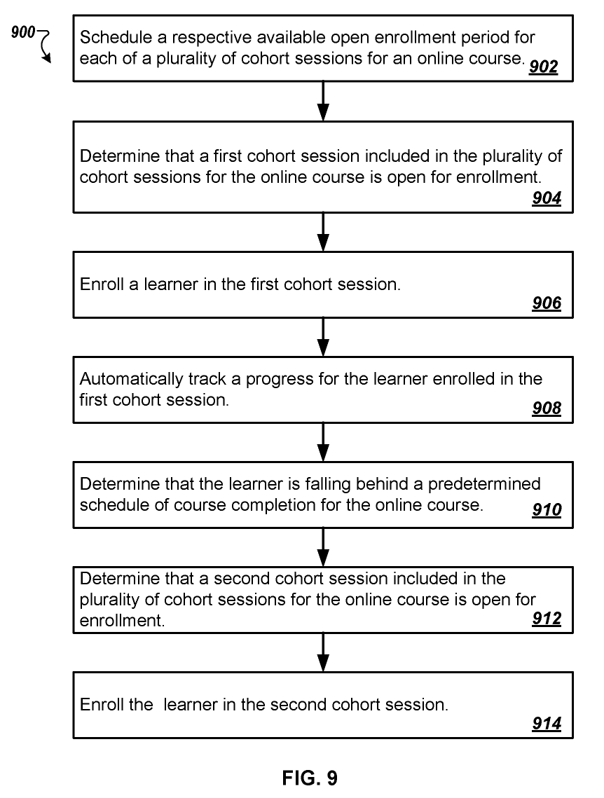

FIG. 9 is a flowchart that illustrates a method 900 for enrolling a learner in a cohort session. In some implementations, the systems described herein can implement the method 900. For example, the method 900 can be described referring to FIGS. 1-8.

A respective available open enrollment period for each of a plurality of cohort sessions for an online course is scheduled (block 902). For example, referring to FIG. 1, the auto-cohort session manager application 144 can access the online course repository 142b for the online course. The auto-cohort session manager application 144 can determine the plurality of cohort sessions stored in association with the online course in the online course repository 142b. For example, the auto-cohort session manager application 144 can determine that a number, n, of cohort sessions are associated with the online course. The auto-cohort session manager application 144 can determine an open enrollment period for each cohort session. For example, referring to FIG. 2, the cohort session one 202 can be associated with the online course. The auto-cohort session manager application 144 can schedule an open enrollment time duration of (x weeks+y days) for the open enrollment period for the cohort session one 202.

It is determined that a first cohort session included in the plurality of cohort sessions for the online course is open for enrollment (block 904). For example, the auto-cohort session manager application 144 can determine that the cohort session one 202 is open for enrollment based on the first time 208.

Enroll a learner in the first cohort session (block 906). The enrolling can be based on the determining that the first cohort session is open for enrollment, For example, a learner can be enrolled in the cohort session one 202 during the enrollment time duration of (x weeks+y days) from the first time 208.

Automatically track a progress for the learner enrolled in the first cohort session (block 908). For example, the auto-cohort session manager application 144 can periodically access the student repository 142c. The student repository 142c can include the outcome of course assessments for the learner for the cohort session one 202 that the learner is currently enrolled in.

It is determined that the learner is falling behind a predetermined schedule of course completion for the online course (block 910). The determining can be based on automatically tracking the progress for the learner. For example, the auto-cohort session manager application 144 can access the online course repository 142b. Included in online course repository 142b and in association with the online course can be a predetermined schedule of course completion for the online course. The auto-cohort session manager application 144 can compare the outcome of course assessments for the learner for the cohort session one 202 that the learner is currently enrolled in to the predetermined schedule of course completion for the online course to determine the progress of the user in the cohort session for the online course.

It is determined that a second cohort session included in the plurality of cohort sessions for the online course is open for enrollment (block 912). The determining can be based on determining that the user is falling behind the predetermined schedule, automatically determining. For example, the auto-cohort session manager application 144 can determine that the cohort session two 204 is open for enrollment based on the third time 216.

Enroll the learner in the second cohort session (block 914). The enrolling can be based on automatically determining that the second cohort session is open for enrollment. For example, a learner can be enrolled in the cohort session two 202 during the enrollment time duration of (w weeks+((u+y) days) from the third time 216.

The enrolling can include retaining a current progress of the learner through the online course. The retaining can include moving completed course assessments from the first cohort session to the second cohort session. For example, the student repository 142c can retain the outcome of course assessments for the learner for the cohort session one 202.

In some implementations, later offered cohort sessions may include updated or different sets of course materials than earlier offered cohort session. For example, the later offered cohort sessions may include different course assessments than earlier offered cohort sessions. In addition or in the alternate, these later offered cohort sessions may have different schedules for the presentation of the course content and/or deadlines for submitting course assessments. The determination of the updated or different sets of course materials and/or the different schedules may be implemented as course improvements over time.

In some implementations, one or more cohort sessions may run concurrently. Each concurrent cohort session may have a different membership eligibility level. For example, during a given enrollment period for an online course, multiple cohort sessions may be offered. A first cohort session may be open for enrollment by the general public. A second cohort session running concurrently with the first cohort session may be open for enrollment for a specific private group of learners.

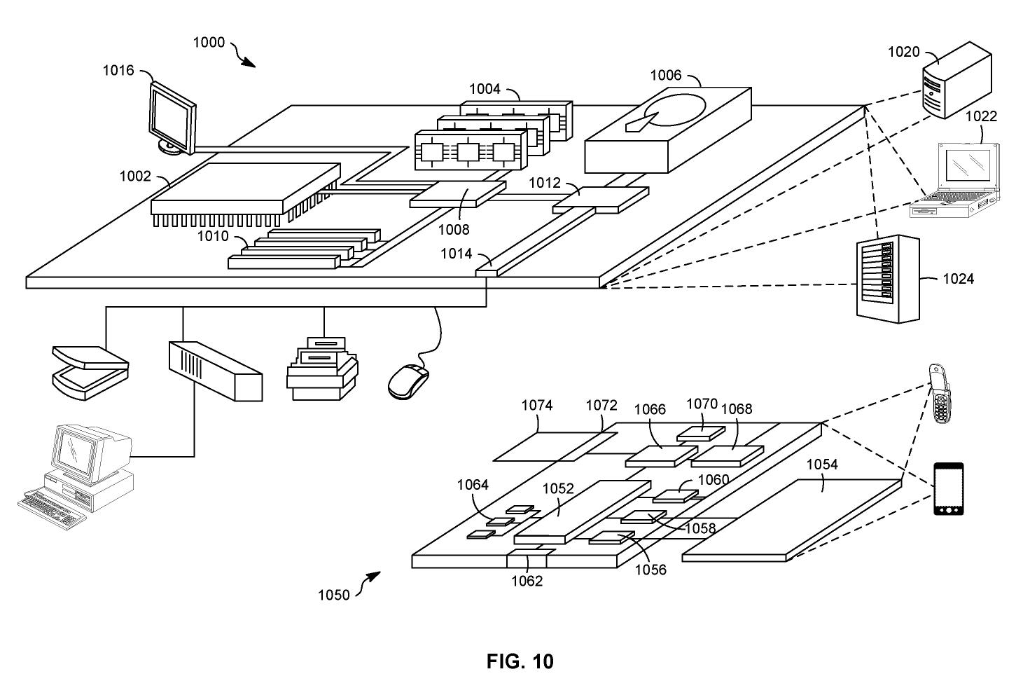

FIG. 10 shows an example of a generic computer device 1000 and a generic mobile computer device 1050, which may be used with the techniques described here. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface 1008 connecting to memory 1004 and high-speed expansion ports 1010, and a low speed interface 1012 connecting to low speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high speed interface 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high speed controller 1008 manages bandwidth-intensive operations for the computing device 1000, while the low speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed expansion port 1014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 1050. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052 that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, WiFi, or other such transceiver (not shown). In addition, GPS (Global Positioning System) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 10100. It may also be implemented as part of a smart phone 8102, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the specification. For example, each claim below and the examples of such claims described above can be combined in any combination to produce additional example embodiments.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
scheduling, by a computer system, a respective available open enrollment period for each of a plurality of cohort sessions for an online course;
determining, by the computer system, that a first cohort session included in the plurality of cohort sessions for the online course is open for enrollment;
enrolling, by the computer system and based on determining the first cohort session is open for enrollment, a learner in the first cohort session;
automatically tracking, by the computer system, a progress for the learner enrolled in the first cohort session;
determining, by the computer system and based on automatically tracking the progress for the learner, that the learner is falling behind a predetermined schedule of course completion for the online course;
based on determining that the learner is falling behind the predetermined schedule, automatically determining, by the computer system, that a second cohort session included in the plurality of cohort sessions for the online course is open for enrollment; and
enrolling, by the computer system and based on automatically determining that the second cohort session is open for enrollment, the learner in the second cohort session, the enrolling comprising retaining, by the computer system, a current progress of the learner through the online course, the retaining including moving completed course assessments from the first cohort session to the second cohort session.

2. The method of claim 1, further comprising:
providing, by the computer system and to a computing device, an indication that the first cohort session is open for enrollment; and
receiving, by the computer system and from the computing device, data indicative of a selection of the first cohort session by the learner.

3. The method of claim 2, further comprising:
providing, by the computer system and to the computing device, an indication that the second cohort session included in the plurality of cohort sessions is open for enrollment; and
receiving, by the computer system and from the computing device, data indicative of a selection of the second cohort session by the learner.

4. The method of claim 3,
wherein the indication that the first cohort session is open for enrollment is displayed in a first user interface on a display device included in a computing device,
wherein the indication that the second cohort session is available for enrollment is displayed in a second user interface on the display device included in the computing device, and
wherein the indication that the learner is falling behind schedule is displayed in a third user interface on the display device included in the computing device.

5. The method of claim 1, wherein the enrolling comprises:
enabling, by the computer system, preview access to the online course, the preview access including access to a subset of course content for the online course.

6. The method of claim 5, wherein the preview access further includes access to a subset of course assessments for the online course.

7. The method of claim 5,
wherein a portion of a time duration for the preview access overlaps a portion of a time duration for the first cohort session, and
wherein the portion of the time duration for the preview access is at a start of the first cohort session.

8. The method of claim 1, wherein the second cohort session is available for enrollment subsequent to a final deadline for the first cohort session.

9. The method of claim 1, wherein a portion of a time duration for the first cohort session overlaps with a portion of a time duration for the second cohort session.

10. The method of claim 1, wherein automatically tracking a progress for the learner enrolled in the first cohort session includes performing, by the computer system, a check of course progress for the learner before an end of the online course.

11. The method of claim 1, wherein automatically tracking a progress for the learner enrolled in the first cohort session includes performing, by the computer system, a check of course progress for the learner before a final deadline for the online course, wherein the final deadline is at an end of a grace period for the online course.

12. The method of claim 1, further comprising:
determining, by the computer system, a number and frequency of offering of the plurality of cohort sessions based on at least one of enrollment data for the online course and learner demand for the online course.

13. The method of claim 1, wherein scheduling a respective available enrollment period for each of the plurality cohort sessions includes providing continuous open enrollment for the online course.

14. The method of claim 1,
wherein the first cohort session includes a first plurality of learners enrolled in the first cohort session, and
wherein the second cohort session includes a second plurality of learners enrolled in the second cohort session.

15. A computer system comprising:
an online course repository including a plurality of online courses and a schedule for completion of each online course;
a student repository including a plurality of outcomes of completed course assessments for a cohort session for an online course, the plurality of outcomes of completed course assessments being stored in the student repository in association with respective learners enrolled in the cohort session for the online course;
a server including:
a course application module configured to present content and course assessments to a learner enrolled in a cohort session for the online course; and
an auto-cohort session manager application module configured to:
schedule a respective available open enrollment period for each of a plurality of cohort sessions for an online course;
determine that a first cohort session included in the plurality of cohort sessions for the online course is open for enrollment;
enroll a learner in the first cohort session;
access the student repository in order to monitor a progress for the learner, the monitoring including accessing a plurality of outcomes of completed course assessments for the first cohort session, the plurality of outcomes being associated with the learner;
determine that the learner is falling behind a schedule for completion of the online course;
based on determining that the learner is falling behind the schedule, determine that a second cohort session included in the plurality of cohort sessions for the online course is open for enrollment; and
based on determining that the second cohort session is open for enrollment:
enroll the learner in the second cohort session; and
retain, in association with the learner, the plurality of outcomes of completed course assessments for first cohort session.

16. The computer system of claim 15, wherein the auto-cohort session manager application module is further configured to access the student repository before an end of the online course when monitoring the progress for the learner.

17. The computer system of claim 15,
wherein the online course repository includes, in association with each online course, enrollment data for the online course and learner demand data for the online course, and
wherein the auto-cohort session manager application module is further configured to determine a number of cohort sessions to include in the plurality of cohort sessions for the online course based on at least one of the enrollment data for the online course and the learner demand data for the online course.

18. A non-transitory, machine-readable medium having instructions stored thereon, the instructions, when executed by a processor, cause a computer system to:
schedule, by the computer system, a respective available open enrollment period for each of a plurality cohort sessions for an online course;
determine, by the computer system, that a first cohort session included in the plurality of cohort sessions for the online course is open for enrollment;
enroll, by the computer system and based on determining the first cohort session is open for enrollment, a learner in the first cohort session;
track, by the computer system, a progress for the learner enrolled in the first cohort session;
determine, by the computer system and based on automatically tracking the progress for the learner, that the learner is falling behind a predetermined schedule of course completion for the online course;
based on determining that the learner is falling behind the predetermined schedule, determine, by the computer system, that a second cohort session included in the plurality of cohort sessions for the online course is open for enrollment; and
enroll, by the computer system and based on automatically determining that the second cohort session is open for enrollment, the learner in the second cohort session, the enrolling comprising retaining, by the computer system, a current progress of the learner through the online course, the retaining including moving completed course assessments from the first cohort session to the second cohort session.

19. The medium of claim 18, wherein the instructions, when executed by the processor, that cause the computer system to the enroll a learner in the first cohort session include instructions that, when executed by the processor, cause the computer system to enable preview access to the online course, the preview access including access to a subset of course content for the online course.

20. The medium of claim 19, wherein the preview access further includes access to a subset of course assessments for the online course.
